(19) United States
(12) Patent Application Publication
(10) Pub. No.: US 2005/0061734 A1
(43) Pub. Date: Mar. 24, 2005

(54) Anti-corrosive engine oil system components

(75) Inventor: Derek Tarrant, Greeneville, TN (US)

Correspondence Address: James D. Wood;ICE MILLER, One American Square, Box 82001, Indianapolis, IN, 46282-0002, US

(73) Assignee: Alltrista Zinc Products, L.P., Greeneville, TN (US)

(21) Appl. No.: 10/667,587

(22) Filed: Sep. 22, 2003

(51) Int. Cl. B01D 39/00

(52) U.S. Cl. 210/500.1

(57) ABSTRACT

The present invention is an oil system component comprising an acid neutralizing metal such as zinc, calcium, cadmium or magnesium, or alloys thereof. According to one embodiment, a multipurpose component is provided by including an acid neutralizing metal in a standard component such as the oil sump, oil screen, and/or oil filter. The present invention is particularly suited for incorporation into a standard oil filter by fabricating the casing and or an internal screen of acid neutralizing metal and/or by incorporating acid neutralizing metallic fibers into the mechanical filter material.

### BACKGROUND

This invention relates generally to the field of oil systems used in internal combustion engines.

Engine oil characteristics are constantly undergoing improvement so as to allow an increased interval between engine oil changes. Similarly, changes in the materials manufacturing processes of engine components have reduced the amount of wear products introduced into the engine oil, allowing an increased interval between engine oil changes. However, with the advent of exhaust gas recirculation in gasoline engines, and potentially for diesel engines, the introduction of acidic exhaust products into the lubricating oil of internal combustion engines has increased many fold. For example, sulphur compounds in internal combustion engines are oxidized in combustion to acidic sulphur dioxide.

The increase in acidic exhaust products, alone or in conjunction with water formed during the combustion process, causes corrosion of internal engine components and reduces the level of additives that are designed to decrease wear and improve performance under extreme pressures. Moreover, other sulphur compounds such as hydrogen sulphide and mercaptans are corrosive when they become incorporated into the engine oil (excess fuel conditions on cold start for example) in their original form and exacerbate the above problems when they become oxidized during combustion. This results in critical reduction of the concentration of the oil additives long before the oil is scheduled to be changed.

Inorganic neutralizing chemicals may be incorporated into the oil system so as to neutralize the acidic exhaust products. However, these neutralizing chemicals may not have consistent or reliable initial particle size distribution. Moreover, these chemicals tend to fracture or undergo other forms of particle reduction under conditions such as impact and/or vibration which are likely to be encountered in, or close to, an internal combustion engine. This may result in the undesired introduction of the salts into the oil pumping or bearing portions of the oil system.

Therefore, it is desirable in an engine oil system to provide a “component” that will neutralize acid introduced into the engine oil. It is desired that the component be compatible with existing oil systems and readily incorporated into new systems. It is further desired that the component be capable of use without the need to introduce additional parts to existent oil systems. It is also desired that the component be easily manufactured and not add significantly to the costs of production, maintenance, or repair of the component and/or oil system. Finally, it is desired that the component typically not fracture or undergo other reduction under conditions likely to be encountered in, or close to, an internal combustion engine.

### BRIEF SUMMARY OF THE INVENTION

The present invention comprises an oil system component which includes an anti-corrosive material such as zinc, magnesium, cadmium, or calcium. The component functions as a filter for acidic exhaust products (“acid filter”) through the use of the anti-corrosive material. When the anti-corrosive material contacts acidic combustion products within the lubricating oil, the acidic combustion products are neutralized. This saves engine corrosion and reduces the degradation of oil additives.

The anti-corrosive material must have a large enough mass and sufficient surface area in contact with the lubricating oil so that the corrosive contaminants can be effectively neutralized before they can substantially attack the internals of the engine or the oil additive package. By sacrificing a portion of the anti-corrosive material, corrosion is substantially reduced and the additive package is protected and can continue performing its intended function.

The benefits of the present invention may be realized in several embodiments. One such embodiment comprises the insertion of thin-gauge plain or perforated sheet in the oil path. For example, a zinc sheet may be located inside the oil filter canister, either separately or pleated with the paper element that comprises the oil filter. The sheet may be very thin, such as a foil, or a comparatively thicker sheet. As used herein, “oil filter” refers to the standard mechanical filtration components well known in the prior art. In order to increase surface area and reduce flow restriction, the foil can be punched with holes, perforated with slits or perforated and expanded into a mesh. This type of modified zinc foil can be loosely placed in an oil filter canister or it can become a more intimate part of the oil filter if used in combination with the porous (typically paper) oil filter media before it is pleated and fabricated into the oil filter element. Alternatively, the zinc foil may be placed in other locations within the oil system so long as there is sufficient contact with the oil. Such locations include the oil sump, oil cooler, or even an external oil processing device.

According to another embodiment of the invention, metallic fibers may be used. The fibers must be controlled and prevented from entering the “clean” side of the lubricating oil system and endangering sensitive bearing surfaces. Prevention of entry into the “clean” side can be accomplished by packing fibers into void spaces in the “dirty” side of a regular or by-pass oil filter where the oil filter element prevents their passage into sensitive areas of the engine. Alternatively, the metallic fibers can be used as an integral part of the oil filter media. The fibrous nature of the metallic fibers will allow it to be incorporated by wet laid or dry laid non-woven techniques to produce a cohesive media construction that binds the fibers firmly into the oil filter media where they can perform their function without becoming dislodged and entering the clean area of the oil system.

As in the case of a metallic sheet, the zinc fibers can be used in locations other than the oil filter. For example the fibers can be placed in the sump or other oil collection areas of the engine, provided the fibers are prevented from entering sensitive areas of the oil pumping and bearing system. Such immobilization can be realized by restraining them within a porous media that allows the passage of oil while preventing the egress of fibers. Alternatively, the fibers could be formed into a compressed fiber component, such as a briquette or compressed acid filter screen, that would hold the fibers secure by virtue of compression and entanglement. Use of such a compressed component allows the use of fibers in the sump, oil reservoir or external oil processing device.

Other embodiments of the present invention may include the use of metallic powder or incorporation of zinc components into the oil system. Zinc powder may be used in a manner similar to metallic fibers, although the powder cannot be formed by compression. Zinc powder may, however, be incorporated on the “dirty” side of the oil filter. Being robust, the zinc powder can be relied upon not to undergo particle size reduction that would produce particles small enough to pass through the oil filter media and damage bearing surfaces.

Metallic components within an internal combustion engine can be placed in contact with the lubricating oil. The components may be included solely for their intended neutralizing purpose (a “special purpose component”) or the component may be a standard component which also provides a neutralizing function (“multipurpose component”). For example the entire engine sump pan could be made from zinc. Alternatively, a zinc sheet could be fabricated into an oil screen, baffle or oil scraper device. Zinc could also be used to form the outer casing of a regular or by-pass oil filter or could comprise some of the internal metal components in the oil filter.

### BRIEF DESCRIPTION OF THE DRAWINGS

FIG. 1 is a partial diagrammatic view of one embodiment an engine oil system in accordance with the present invention.

FIG. 2 is a perspective view of a piston in accordance with the present invention.

FIG. 3 is a bottom plan view of the combined acid and oil filter of the embodiment of FIG. 1.

FIG. 4 is a cutaway side view of the combined acid and oil filter of the embodiment of FIG. 1.

FIG. 5 is a partial perspective view of an alternative embodiment of a combined acid and oil filter according to the present invention without the outer casing.

### DETAILED DESCRIPTION OF THE INVENTION

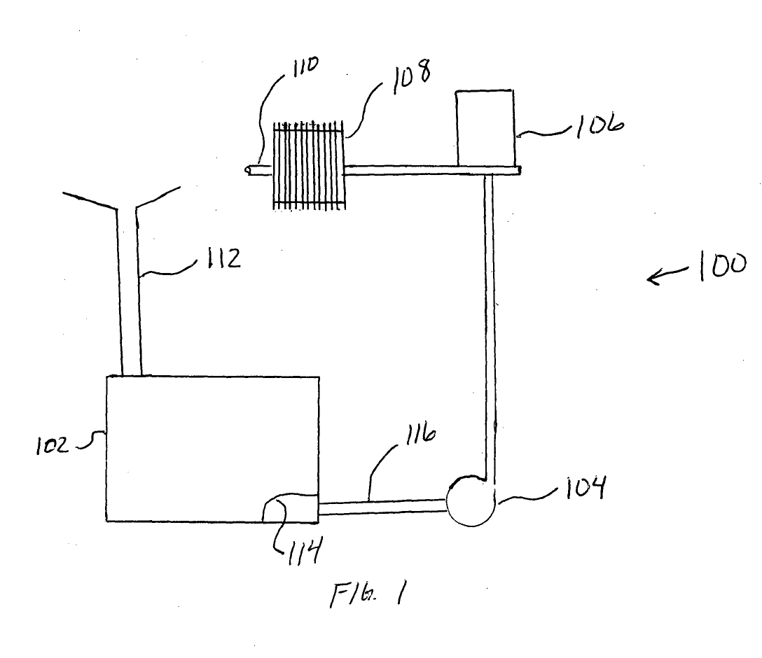

Referring to FIG. 1, one embodiment of the present invention is described. FIG. 1 shows a diagram of a typical engine oil system as improved according to the present invention. Oil system 100 comprises sump pan 102. Sump pan 102 is a removable metal chamber or bowl. Sump pan 102 is located at the bottom of the crankcase and provides for storage of the engine system oil. Typically, an oil drain plug is located at the bottom of this pan (not shown in FIG. 1) and can be removed to allow old oil to flow out of the vehicle during an oil change. In one embodiment of the present invention, sump pan 102 is made of zinc. Sump pan 102 thus comprises a multipurpose component as it also provides the function of an acid filter.

Sump pan 102 is connected to oil pump 104 through oil screen 114 and supply pipe 116. Oil screen 114 is a coarse-mesh metal screen that prevents foreign matter, such as lost washers, nuts and bolts, from entering oil pump 104. Oil is allowed to pass through oil screen 114 since it is a porous sheet. In one embodiment of the present invention, oil screen 114 is made of zinc. Oil screen 114 thus comprises a multipurpose component as it also provides the function of an acid filter.

Oil system 100 further comprises combined acid and oil filter 106, oil cooler 108, oil supply header 110, and oil return header 112.

In operation, oil sump pan 102 is partially filled with oil. Oil pump 104 creates a suction on oil sump pan 102. Large objects are kept from the suction of oil pump 104 by oil screen 114, which is also referred to as an oil pump strainer. Oil pump 104 forces oil through combined acid and oil filter 106 where small particles are filtered out of the oil. The oil then passes through oil cooler 108, where the temperature of the oil is controlled in a manner well known in the relevant art. After passing through oil cooler 108, the oil is supplied under pressure to lubricated parts through header 112. Oil from lubricated parts is returned to sump pan 102 through oil return header 112.

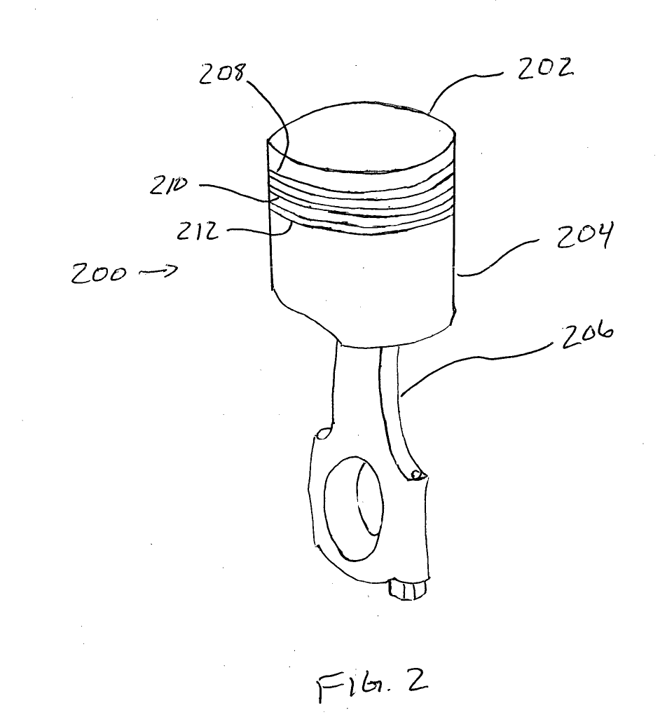

Referring now to FIG. 2, a perspective view of a piston ring is shown. Piston ring 200 comprises crown 202, skirt 204 and connecting rod 206. Also shown are seals 208 and 210 and oil scraper 212. Oil scraper 212 scrapes oil off of the cylinder wall, and returns it to sump pan 102 via small oil return holes in the piston (not shown) behind oil scraper 212. Thus, oil scraper 212 is considered herein to form a component in the oil system. In one embodiment of the present invention, oil scraper 212 is made from zinc. Oil scraper 212 thus comprises a multipurpose component as it also provides the function of an acid filter.

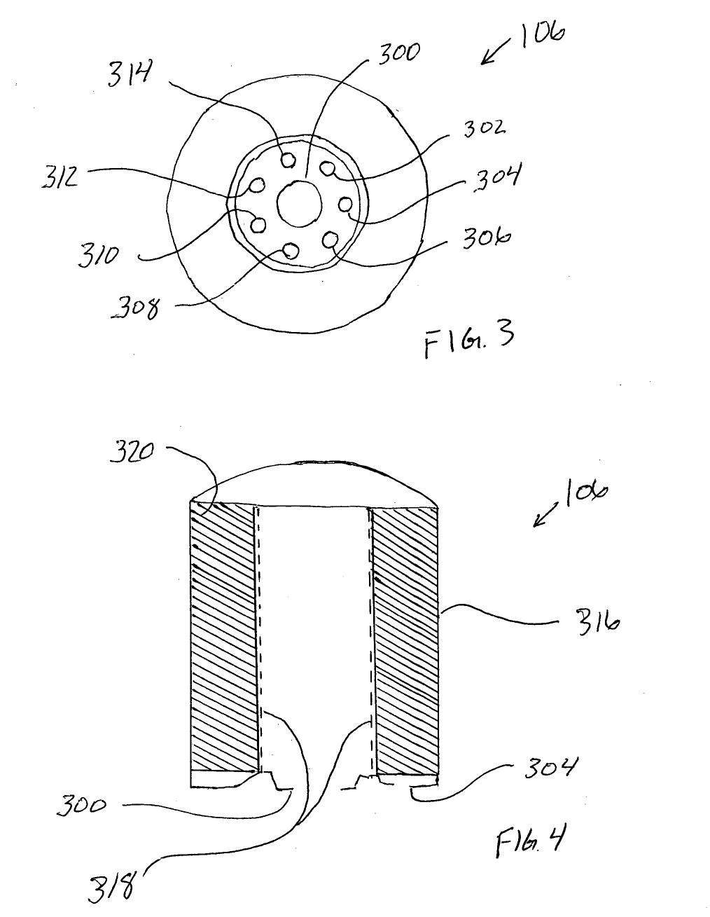

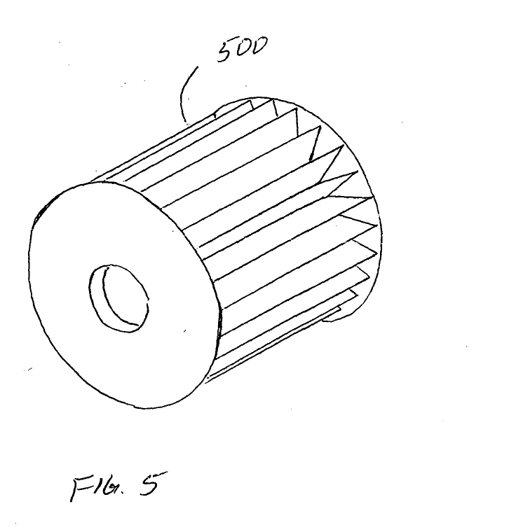

FIG. 3 shows a bottom plan view of multipurpose filter 106. Multipurpose filter 106 comprises supply port 300, and clean oil return ports 302, 304, 306, 308, 310, 312 and 314. With reference to FIG. 4, multipurpose filter 106 further comprises outer casing 316, inner screen 318 and filter batting 320. Both inner mesh 318 and filter batting 320 are made from porous sheets of material, allowing oil to flow from oil pump 104 through supply port 300, past inner mesh 318 and filter batting 320, and out to supply header 110 through clean oil return ports 302, 304, 306, 308, 310, 312 and 314.

According to one embodiment of the present invention, inner mesh 318 is made from zinc. Accordingly, as oil passes through inner mesh 318, acid products within the oil is neutralized by the zinc. Inner mesh 318 may be fabricated according to a variety of processes. For example, a sheet of zinc may be produced, and the punctured such that oil can pass through. Alternatively, a mat of metallic fibers, such as zinc fibers can be made according to processes known in the relevant art. Zinc fibers may be manufactured, by way of example, according the method of U.S. patent application Ser. No. 10/083,196, the teachings of which are incorporated herein by reference.

Those of skill in the art will appreciate that a number of variations of the present invention are possible. By way of example, but not of limitation, metal fibers may be incorporated into the porous filter material. The porous filter material may be a single sheet such as is shown in FIG. 4, it may be layered, or it may be in some other form such as a shaped sheet. With reference to FIG. 5, porous material 500 is shown as being shaped into a pleated form.

Moreover, the selection of the component or components to incorporate acid neutralizing metal may be varied. Additionally and/or alternatively, a component may be added to the engine oil system to provide an acid neutralizing component. By way of example, but not of limitation, an acid filter could be provided intermediate the oil filter and the rest of the oil system, such that the oil filter “piggybacks” onto the acid filter.

Additionally, a variety of metals and/or metal alloys may be used to provide the acid neutralizing metal of the present invention. By way of example, but not of limitation, the metal could comprise zinc, magnesium, cadmium, and/or calcium, or metal alloys thereof.

Accordingly, the present invention provides a component that will neutralize acid introduced into the engine oil. The present invention is compatible with existent oil systems and readily incorporated into new systems. The present invention is capable of being used without the need to introduce additional parts to existent oil systems. The present invention is also easily manufactured and need not add significantly to the cost of production of the component and/or oil system into which it is incorporated. Moreover, the present invention may be incorporated into a component that will typically not fracture or undergo other reduction under conditions likely to be encountered in, or close to, an internal combustion engine.

While the present invention has been described in detail with reference to certain exemplary embodiments thereof, such are offered by way of non-limiting example of the invention, as other versions are possible. Moreover, a number of design choices exist within the scope of the present invention, some of which have been discussed above. It is anticipated that a variety of other modifications and changes will be apparent to those having ordinary skill in the art and that such modifications and changes are intended to be encompassed within the spirit and scope of the invention as defined by the following claims.

1. An engine oil system acid filter comprising,
metallic fibers, the metallic fibers capable of neutralizing acid.

2. The filter of claim 1, further comprising,
a porous sheet, the porous sheet comprising the metallic fibers.

3. The filter of claim 2, wherein the porous sheet further comprises non-metallic fibers.

4. The filter of claim 2, wherein the metallic fibers comprise at least one of the following list of metals or alloys thereof,
zinc,
magnesium,
cadmium, or
calcium.

5. An improved engine oil system, wherein the improvement comprises,
a multipurpose component made with metal capable of neutralizing acid, the multipurpose component in contact with oil.

6. The improved engine oil system of claim 5, wherein the multipurpose component is one of the following list of components,
a sump pan,
an oil screen,
a porous oil filter,
a baffle,
an oil scraper, or
an outer casing of a filter.

7. The improved engine oil filter of claim 6, wherein the multipurpose component comprises at least one of the following list of metals or alloys thereof,
zinc,
magnesium,
cadmium, or
calcium.

8. A filter for use in an engine oil system comprising,
a porous sheet, the porous sheet comprising a metal capable of neutralizing acid.

9. The filter of claim 8, wherein the porous sheet comprises,
a foil, the foil having openings therethrough.

10. The filter of claim 8, further comprising,
a mechanical filtration material.

11. The filter of claim 8, wherein the porous sheet comprises at least one of the following list of metals or alloys thereof,
zinc,
magnesium,
cadmium, or
calcium.

12. An engine oil system acid filter comprising,
metallic powder, the metallic powder capable of neutralizing acid

13. The acid filter of claim 12, the acid filter further comprising,
a porous sheet, the sheet having pores sized such that oil may pass through the pores but the metallic powder may not pass through the pores.

14. The acid filter of claim 13, wherein the acid filter comprises,
an oil filter, the oil filter having an inlet and an outlet, the oil filter comprising,
a dirty side proximate to the inlet, and
a clean side proximate the outlet, and wherein
the porous sheet is positioned between the dirty side and the clean side, and
the metallic powder is positioned between the inlet of the oil filter and the porous sheet.

15. The acid filter of claim 14, wherein the metallic powder comprises at least one of the following list of metals or alloys thereof,
zinc,
magnesium,
cadmium, or
calcium.
